(19) United States
(12) Patent Application Publication
(10) Pub. No.: US 2015/0345378 A1
(43) Pub. Date: Dec. 3, 2015

(54) Method for the Operation of an Internal Combustion Engine

(71) Applicant: AVL LIST GMBH, Graz (AT)

(72) Inventors: Mestre Ricardo Afonso Pereira Braz Abrantes, Graz (AT); Hans Felix Seitz, Graz (AT)

(73) Assignee: AVL LIST GMBH, Graz (AT)

(21) Appl. No.: 14/728,074

(22) Filed: Jun. 2, 2015

(30) Foreign Application Priority Data
Jun. 2, 2014 (AT) A 50382/2014

(51) Int. Cl. F02B 37/24

(52) U.S. Cl. CPC F02B 37/24

(57) ABSTRACT

The invention relates to a method for operating an internal combustion engine (1) with an exhaust system (4), especially a gas engine, where a first partial exhaust gas flow (6) is led through a first exhaust gas turbine (8) of a first exhaust gas turbocharger (9) and a second partial exhaust gas flow (7) is led through a second exhaust gas turbine (12), the exhaust gas being passed through the first and second exhaust gas turbines (8, 12) in parallel flows, where the second partial exhaust gas flow (7) is controlled, and where in at least one operating range of the engine the second partial exhaust gas flow (7) is controlled by the second exhaust gas turbine (12).

In order to control the total power of an internal combustion engine in as simple and efficient way as possible it is provided that in the case of load increase the second partial exhaust gas flow (7) is at first throttled or interrupted until the increased load level is attained and is then slowly increased again until the output power of the second exhaust gas turbine (12) at the present load level is reached, with preferably the first partial exhaust gas flow (6) being controlled with regard to optimum efficiency of the first exhaust gas turbocharger (9).

The invention relates to a method for operating an internal combustion engine with an exhaust system, in particular a gas engine, where a first partial flow of exhaust gas is led through a first exhaust gas turbine of a first exhaust gas turbocharger and a second partial flow of exhaust gas is led through a second exhaust gas turbine, the exhaust gas being passed through the first and second exhaust gas turbines in parallel flows, and where the second partial exhaust gas flow is controlled, and where in at least one operating range of the engine the second partial exhaust gas flow is controlled by the second exhaust gas turbine,

From EP 2 087 222 B1 there is known an internal combustion engine with a first and a second exhaust gas turbocharger, where a first partial exhaust gas flow is led through a first exhaust gas turbine of a first exhaust gas turbocharger and a second partial exhaust gas flow is led through a second exhaust gas turbine of a second exhaust gas turbocharger and the exhaust gas flows through the first and second exhaust gas turbine in parallel. The second exhaust gas turbine is located in an exhaust gas recirculation line and has variable turbine geometry. The flow of recirculated exhaust gas is controlled by varying the geometry of the second exhaust gas turbine.

EP 2 042 705 A1 describes a turbo-compound internal combustion engine with an intake system and an exhaust system, where a first turbocharger is positioned in the intake system. A first turbine for driving the first turbocharger is placed in an outlet line of the exhaust system. A second turbine is placed in a second outlet line of the exhaust system to provide mechanical energy for the internal combustion engine. Furthermore a second turbocharger is positioned in the intake system receiving mechanical energy from the internal combustion engine or the second turbine. In at least one operating region of the motor the exhaust gas flow is passed through the second turbine.

EP 2 639 440 A1 discloses an internal combustion engine with a first and a second exhaust gas turbocharger, the turbines of the exhaust gas turbochargers being placed in the exhaust system in parallel. The chargers of the exhaust gas turbines are arranged either in series or in parallel.

From JP 2009-257097 A there is known an internal combustion engine with two exhaust gas turbochargers placed in parallel in the exhaust line and in the intake line.

Furthermore from U.S. Pat. No. 6,324,846 A1 there is known an internal combustion engine with a plurality of exhaust gas turbochargers, with two exhaust gas turbines being located in the exhaust line one behind the other, The internal combustion engine features an exhaust gas recirculating line, in which is disposed the exhaust gas turbine of yet another exhaust gas turbocharger.

It is the object of the present invention to control combustion in an internal combustion engine in as simple a manner as possible.

According to the invention this object is achieved by proposing that in the case of load increase the second partial flow of exhaust gas should be throttled or interrupted until the higher load level is reached and should then be slowly increased again until the output power of the second exhaust gas turbine is reached for the load level present, with preferably the first partial exhaust gas flow being controlled for optimum efficiency of the first exhaust gas turbo charger.

The second exhaust gas turbine is configured as a power turbine which is either mechanically connected to the drive shaft of the internal combustion engine or drives a conveyor pump for an operating medium or is connected to a generator producing electrical energy.

Preferably at least in one full load operating region the second partial exhaust gas flow is controlled to achieve a targetted power level and the first partial exhaust gas flow is controlled to achieve optimum efficiency of the first exhaust gas turbocharger, with preferably the ratio of first and second partial exhaust gas flow being controlled.

At least in one region of partial load operation the first partial exhaust gas flow may be controlled to achieve targetted power.

It is of particular advantage if control of the first and second partial exhaust gas flow is carried out by varying the turbine geometry of the first or second exhaust gas turbine or by actuating a bypass valve of the first or second exhaust gas turbine.

In case the geometry of the second exhaust gas turbine is not variable control of the through-flow of the second partial exhaust gas flow may be effected by a control valve preferably located upstream of the second exhaust gas turbine.

The invention is preferably applied in internal combustion engines with high-pressure exhaust gas recirculation systems, a branch-off from the exhaust system being provided upstream of the first and/or second partial exhaust gas flow and recirculation being effected into an intake flow of the internal combustion engine, preferably on the high-pressure side. In the case of exhaust gas recirculation the first partial exhaust gas flow is controlled in such a way that the charging pressure required for the desired operating point is produced by a first compressor of the first exhaust gas turbocharger, which is mechanically connected to the first exhaust gas turbine, while the second partial exhaust gas flow is controlled such that high-pressure recirculation is enabled by a second compressor positioned in the exhaust gas recirculation line and mechanically connected to the second exhaust gas turbine.

The invention will now be described in more detail referring to the enclosed drawings.

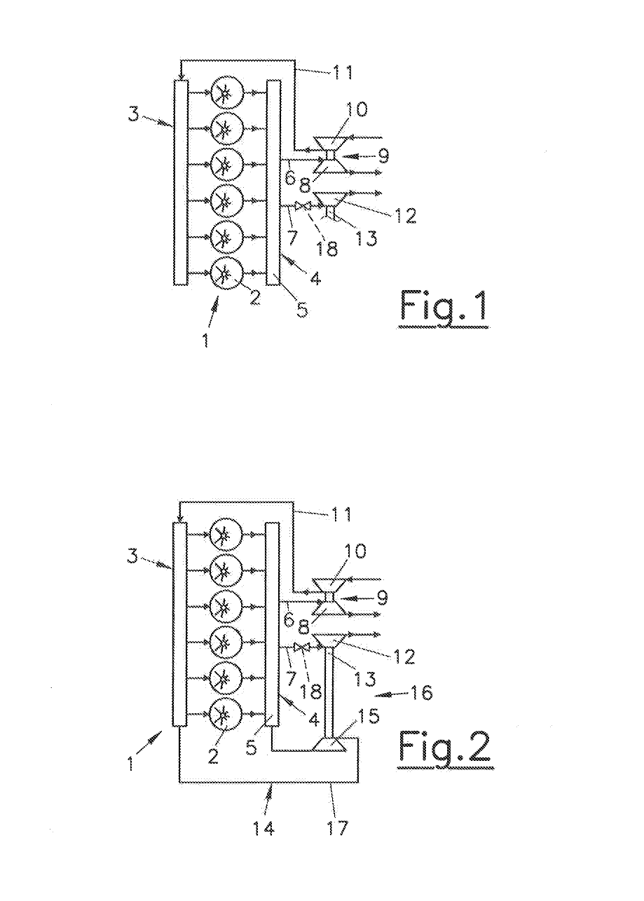

FIGS. 1 and 2 schematically show internal combustion engines for application of the method of the invention.

The internal combustion engine 1 shown in each figure, for instance a gas engine, has a number of cylinders 2, an intake system 3 for intake flow, and an exhaust system 4 for exhaust gas flow. Downstream of an exhaust gas manifold 5 the exhaust gas flow is partitioned into a first partial exhaust gas flow 6 and a second partial exhaust gas flow 7, a first exhaust gas turbine 8 of a first exhaust gas turbocharger 9 being located in the first partial exhaust gas flow 6, whose first compressor 10 is disposed in the intake line 11 of the intake system 3. In the second partial exhaust gas flow 7 there is disposed a second exhaust gas turbine 12 (power turbine), whose output shaft 13 may be mechanically connected to the internal combustion engine 1, to another compressor (not shown here), to a pump or to a generator producing work.

The first exhaust gas turbine 8 and/or the second exhaust gas turbine 12 may have variable turbine geometry or may be bypassed by a bypass valve (waste gate) not further shown. Especially in the case of non-variable turbine geometry a control valve may precede at least the second exhaust gas turbine 12; in the drawings this valve is indicated by 18. The control valve 18 is necessary in the case of non-variable turbine geometry, but may also be of advantage in the case of variable geometry.

The internal combustion engine 1 shown in FIG. 2 differs from that of FIG. 1 insofar as a (high-pressure) exhaust gas recirculation system 14 is disposed between the exhaust gas system 4 and the intake system 3. A second compressor 15 of a second exhaust gas turbocharger 16 is disposed in the exhaust gas recirculation line 17. Said compressor 15 is connected to the output shaft 13.

The exhaust gas issuing from the exhaust gas manifold 5 is partitioned into a first and a second exhaust gas flow 6, 7 and flows in parallel through the first and second exhaust gas turbine 8, 12 prior to being fed to exhaust gas post-treatment devices, not further shown.

Following are possible operating strategies:

(1) EGR Control (FIG. 2)

Mass flow through the first exhaust gas turbine 8 of the exhaust gas turbocharger 9 is controlled in such a way that the desired charging pressure can be provided by means of the layout of the turbocharger 9, either by actuating a bypass valve (waste gate) or by varying the variable turbine geometry of the first exhaust gas turbine 8. Mass flow through the second exhaust gas turbine 12 is controlled in such a way that enough charging pressure is generated to enable recirculation of exhaust gas to the internal combustion engine 1. The output shaft 13 of the second exhaust gas turbine 12 is connected in this case to a second compressor, which is situated in the exhaust line of the exhaust gas recirculation system 14.

Energy loss due to a waste gate may be decreased, making high-pressure exhaust gas recirculation possible.

(2) Partial Load/Full Load Control

In full load operation mass throughput through the second exhaust gas turbine 12 is controlled in such a way that the desired output power can be achieved, while mass throughput through the first exhaust gas turbine 8 of the turbocharger 9 is controlled such that optimum turbocharger effiency can be achieved.

Control may be effected by varying the ratio of mass throughputs or volume throughputs of the two exhaust gas turbines 8, 12.

In partial load operation mass throughput through the first and/or the second exhaust gas turbine is controlled, control being effected either by varying the geometry of the turbines or by employing a bypass valve (waste gate).

The energy of the bypass valve may be recovered and an increased recovery of exhaust gas energy may be achieved without growth of exhaust gas pressure in the exhaust manifold at high engine speeds.

(3) Response Behaviour at Sudden Load Demand

In the case of sudden load demand the second exhaust gas flow 7 through the second exhaust gas turbine 12 is at first throttled or interrupted until the higher load level of the internal combustion engine 1 is reached by additional fuel and/or combustion air intake. Then the second partial exhaust gas flow 7 is again increased until the desired output power of the second exhaust gas turbine 12 is attained at increased load level of the internal combustion engine, The first partial exhaust gas flow 6 is controlled in such a way that the optimum efficiency of the exhaust gas turbocharger 9 is reached.

The smaller mass moment of inertia of an accordingly designed smaller first exhaust gas turbine 8 of the exhaust gas turbocharger 9 combined with increased mass throughput through the exhaust gas turbine 8 of turbo charger 9 will result in faster increase of charging pressure, leading to faster response behaviour of the internal combustion engine 1.

(4) Combustion Performance

By regulating the mass throughput of the second partial exhaust gas flow 7 through the second exhaust gas turbine 12 the output power of the second exhaust gas turbine 12 can be controlled. In this way the output power of the combustion system can be controlled without varying the mechanical power at the drive shaft of the internal combustion engine 1.

Thus the second exhaust gas turbine 12 may be operated in an operational mode which minimizes the total energy released by combustion for given load, engine speed and other operational parameters. This will result in better efficiency at all engine speeds than formerly possible with known operating methods, with high-pressure exhaust gas recirculation possible if needed. This will result in lower peak combustion pressure and a reduction of irregular combustion effects.

1. A method for operating an internal combustion engine with an exhaust system, wherein a first partial exhaust gas flow is led through a first exhaust gas turbine of a first exhaust gas turbocharger and a second partial exhaust gas flow is led through a second exhaust gas turbine, the exhaust gas being passed through the first and second exhaust gas turbines in parallel flows, where the second partial exhaust gas flow is controlled, and where in at least one operating range of the engine the second partial exhaust gas flow is controlled by the second exhaust gas turbine, wherein in the case of load increase the second partial exhaust gas flow is at first throttled or interrupted until the increased load level is attained, and is then slowly increased again until the output power of the second exhaust gas turbine at the present load level is reached.

2. The method according the claim 1, wherein in at least one full load operating range the second partial exhaust gas flow is controlled with regard to the targeted output power of the second exhaust gas turbine and the first partial exhaust gas flow is controlled with regard to optimum efficiency of the first exhaust gas turbocharger.

3. The method according to claim 1, wherein in at least one partial load operating range the first and/or second partial exhaust gas flow is controlled with regard to the targeted output power.

4. The method according to claim 1, wherein control of the first partial exhaust gas flow is effected by varying the turbine geometry of the first exhaust gas turbine or by actuating a bypass valve of the first exhaust gas turbine.

5. The method according to claim 1, wherein control of the second partial exhaust gas flow is effected by varying the turbine geometry of the second exhaust gas turbine or by actuating a bypass valve of the second exhaust gas turbine.

6. The method according to claim 1, wherein upstream of the first and/or second partial exhaust gas flow a branch-off from the exhaust system is provided, and recirculation is effected into an intake system of the internal combustion engine.

7. The method according to claim 6, wherein for exhaust gas recirculation the first partial exhaust gas flow is controlled in such a way that a charging pressure required for the desired operating point is generated by a first compressor of the first exhaust gas turbocharger mechanically connected to the first exhaust gas turbine, and the second partial exhaust gas flow is controlled in such a way that a second compressor mechanically connected to the second exhaust gas turbine and located in the exhaust gas recirculation line enables high-pressure exhaust gas recirculation.

8. The method according to claim 1, wherein in the case of non-variable turbine geometry of the second exhaust gas turbine, control of the through-flow volume of the second partial exhaust gas flow is effected by a control valve.

9. The method according to claim 1, comprising controlling the first partial exhaust gas flow with regard to optimum efficiency of the first exhaust gas turbocharger.

10. The method according to claim 2, comprising controlling a ratio of first partial exhaust gas flow to second partial exhaust gas flow.

11. The method according to claim 6, wherein the branch-off from the exhaust system is provided in the area of an exhaust manifold.

12. The method according to claim 6, wherein recirculation is effected on the high-pressure side.

13. The method according to claim 8, wherein the control valve is located upstream of the second exhaust gas turbine.

14. The method according to claim 1, wherein the internal combustion engine is a gas engine.
